(19) United States
(12) Patent Application Publication
(10) Pub. No.: US 2025/0266909 A1
(43) Pub. Date: Aug. 21, 2025

(54) AUDIO-BASED MULTI-CHANNEL DATA TRANSMISSION METHOD AND DEVICE, AND STORAGE MEDIUM

(71) Applicant: GOERTEK INC., Weifang, Shandong (CN)

(72) Inventor: Jiale SHANG, Weifang, Shandong (CN)

(21) Appl. No.: 18/859,617

(22) PCT Filed: Jun. 29, 2022
(86) PCT No.: PCT/CN2022/102347

§ 371 Date: Oct. 24, 2024

(30) Foreign Application Priority Data
Apr. 29, 2022 (CN) 202210468527.1

(51) Int. Cl. H04B 11/00; H04B 17/309; H04W 12/03

(52) U.S. Cl. CPC H04B 11/00; H04B 17/346; H04W 12/03

(57) ABSTRACT

Disclosed in the present disclosure are audio-based multi-channel data transmission method and device, and a storage medium, the audio-based multi-channel data transmission method comprises: acquiring multi-channel data in a target scene; processing the multi-channel data on the basis of a preset audio play strategy to obtain target audio data; and playing the target audio data to be received by a second device, and analyzing the target audio data to obtain the multi-channel data. The present disclosure solves the technical problem of relatively low data transmission efficiency caused by poor network signals in a current environment.

The present disclosure claims the priority to the Chinese Patent Application No. 202210468527.1, entitled “AUDIO-BASED MULTI-CHANNEL DATA TRANSMISSION METHOD AND DEVICE, AND STORAGE MEDIUM” filed with China Patent Office on Apr. 29, 2022, the entire contents of which are incorporated into the present disclosure by reference.

### TECHNICAL FIELD

The present disclosure relates to a technical field of data interaction, and more particularly, to an audio-based multi-channel data transmission method and device, and a storage medium.

### DESCRIPTION OF RELATED ART

Currently, in VR/AR multi-person application scenes, data interaction manners between users are unitary and most of them need to rely on a network environment and product equipment having unified specifications for data interaction. Data transmission needs to be performed through the network during the transmission process. However, when the network signals in a current environment is poor, the efficiency of data transmission is low.

### SUMMARY

A main object of the present disclosure is to provide an audio-based multi-channel data transmission method and device, and a storage medium, aiming at solving the technical problem in the prior art that the data transmission efficiency is relatively low due to poor network signals in a current environment.

In order to achieve the above object, the present disclosure provides an audio-based multi-channel data transmission method, which is applied to a first device, the first device at least includes a playing terminal. The audio-based multi-channel data transmission method includes:
acquiring multi-channel data in a target scene;
processing the multi-channel data on the basis of a preset audio play strategy to obtain target audio data; and
playing the target audio data to be received by a second device, and analyzing the target audio data to obtain the multi-channel data.

In order to achieve the above object, the present disclosure also provides an audio-based multi-channel data transmission method, which is applied to a second device, the second device at least includes a receiving terminal. The audio-based multi-channel data transmission method includes:
receiving target audio data played by a playing terminal in the first device; and
analyzing the target audio data on the basis of a preset analyzing strategy to obtain multi-channel data.

The present disclosure also provides audio-based multi-channel data transmission apparatus, which is virtual apparatus, the audio-based multi-channel data transmission apparatus is applied to the first device. The audio-based multi-channel data transmission apparatus includes:
an acquisition module configured to acquire multi-channel data in a target scene;
a processing module configured to process the multi-channel data on the basis of a preset audio play strategy to obtain target audio data; and
a playing module configured to play the target audio data to be received by a second device, and to analyze the target audio data to obtain the multi-channel data.

The present disclosure also provides audio-based multi-channel data transmission apparatus, which is virtual apparatus, the audio-based multi-channel data transmission apparatus is applied to the second device. The audio-based multi-channel data transmission apparatus includes:
a receiving module configured to receive target audio data played by a playing terminal in the first device; and
a analyzing module configured to analyze the target audio data on the basis of a preset analyzing strategy to obtain multi-channel data.

The present disclosure also provides an audio-based multi-channel data transmission device, which is a physical device. The audio-based multi-channel data transmission device includes: a memory, a processor, and an audio-based multi-channel data transmission program stored in the memory, wherein the audio-based multi-channel data transmission program is executed by the processor to implement steps of the audio-based multi-channel data transmission method as described above.

The present disclosure also provides a storage medium, which is a computer-readable storage medium, wherein an audio-based multi-channel data transmission program is stored in the computer-readable storage medium. The audio-based multi-channel data transmission program is executed by a processor to implement steps of the audio-based multi-channel data transmission method as described above.

The present disclosure provides an audio-based multi-channel data transmission method and device, and storage medium. In the present disclosure, multi-channel data in a target scene is obtained at first, and then the multi-channel data is processed on the basis of a preset audio play strategy to obtain target audio data, further, the target audio data is played to be received by a second device, and the target audio data is analyzed to obtain the multi-channel data, thereby processing data into the form of audio data for data transmission, thereby eliminating the need to use a network, therefore, even when the network signal is poor, data transmission can be achieved, and multiple different types of data can be transmitted simultaneously in the form of audio, thereby greatly improving data efficiency.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

In order to more clearly illustrate the embodiments of the present disclosure or the technical solutions in the prior art, the drawings required to be used for the content of the embodiments or the prior art will be briefly introduced in the following. Obviously, for those of ordinary skill in the art, other drawings can also be obtained from the provided drawings without any creative effort.

FIG. 1 is a schematic flowchart of a first embodiment of an audio-based multi-channel data transmission method in the present disclosure;

FIG. 2 is a schematic diagram of a device hardware module structure in an embodiment of the present disclosure;

FIG. 3 is a schematic flowchart of a second embodiment of an audio-based multi-channel data transmission method according to the present disclosure;

FIG. 4 is a principle diagram of configuring different types of data into dual-channel audio data;

FIG. 5 is a principle diagram of generating a first reverse noise level in an embodiment of the present disclosure;

FIG. 6 is a schematic flowchart of a third embodiment of an audio-based multi-channel data transmission method in the present disclosure;

FIG. 7 is a schematic flowchart of a fourth embodiment of an audio-based multi-channel data transmission method in the present disclosure;

FIG. 8 is a schematic flowchart of a fifth embodiment of an audio-based multi-channel data transmission method in the present disclosure;

FIG. 9 is a schematic flowchart of the overall flow of the audio-based multi-channel data transmission method of the present disclosure;

FIG. 10 is a structural schematic diagram of an audio-based multi-channel data transmission device in a hardware operating environment according to an embodiment of the present disclosure; and

FIG. 11 is a schematic diagram of functional modules of audio-based multi-channel data transmission apparatus of the present disclosure.

The realization of the purpose, functional features and advantages of the present disclosure will be further explained in conjunction with embodiments and with reference to the accompanying drawings.

### DETAILED DESCRIPTIONS

It should be understood that the specific embodiments described herein are only used to explain the present disclosure and are not used to limit the present disclosure.

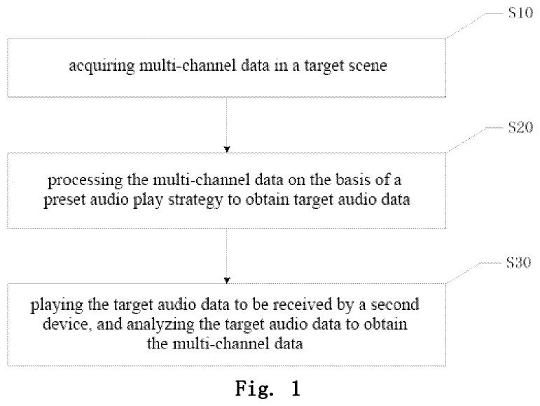

The present disclosure provides an audio-based multi-channel data transmission method, which is applied to a first device. In a first embodiment of the audio-based multi-channel data transmission method in the present disclosure, as shown in FIG. 1, the audio-based multi-channel data transmission method includes:

Step S10: acquiring multi-channel data in a target scene.

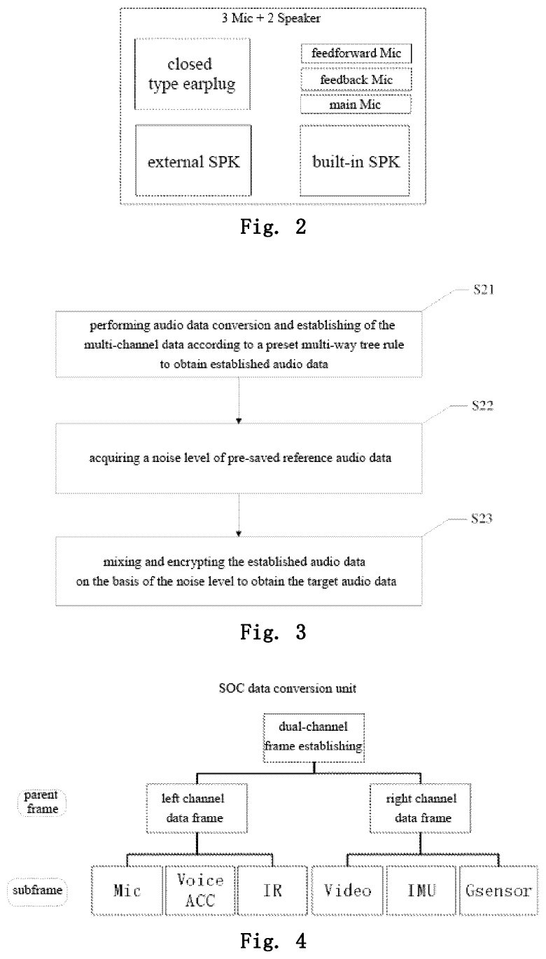

In the embodiment, it should be noted that: referring to FIG. 2, FIG. 2 is a schematic diagram of a device hardware module structure in an embodiment of the present disclosure, wherein the first device includes a VR device, an AR device, etc. Specifically, the first device includes a closed type earplug, a preset number of microphones (mic), and a playback module, the closed type earplug is used to isolate the sound of the surrounding environment, the microphone includes a feedforward microphone, a feedback microphone and a main microphone, the feedforward mic is used to record external environment audio, the feedback mic is used to perform audio passthrough output and noise reduction, the playback module includes a built-in speaker and an external speaker, the built-in speaker is used to perform conventional audio playback, for example, conventional music playback, etc., and the external speaker is used to play preset reference audio data and the audio data after processing the multi-channel data in the present disclosure.

It should be further explained that the multi-channel data are different types of data collected by different sensors, and the different sensors include but are not limited to MIC audio sensors, Voice ACC audio sensors, IMU inertial sensors, IR infrared sensors, visual sensors, and gravity sensors, etc.

Specifically, the acquiring multi-channel data in a target scene includes collecting different types of data in the current scene by a plurality of sensors to obtain the multi-channel data so as to perform data transmission interaction for different types of data.

Before the step of acquiring multi-channel data in a target scene, the method further includes:
Step a1: playing preset reference audio data in the target scene so that a receiving terminal in the first device receives the reference audio data; and
Step a2: calculating and saving a noise level and a distance attenuation sensitivity of the reference audio data on the basis of a difference between the played reference audio data and the received reference audio data.

In the embodiment, it should be noted that the noise level refers to a sound pressure level, a sound intensity level and a sound power level (in dB) measured by a sound level meter, which reflect the strength of the noise, as well as the A sound level and equivalent A sound level (in dB) that reflects the psychological and physiological perception of people to noise. The distance attenuation sensitivity is related to a transmission distance, and refers to audio attenuation sensitivities corresponding to different transmission distances in a process of the audio propagation.

In the embodiment, specifically, the reference audio data is played by the external speaker (playing terminal) of the first device, and then the reference audio data is received by the feedforward mic (receiving terminal) in the first device, so that spontaneous transmission and reception of audio is realized by the playing terminal and the receiving terminal in the device, and then the noise level and the distance attenuation sensitivity of the reference audio data in the target scene are calculated. Here, the calculation method of the noise level and the distance attenuation sensitivity belong to the prior art, which will not be repeated here.

Step S20: processing the multi-channel data on the basis of a preset audio play strategy to obtain target audio data.

In the embodiment, it should be noted that the audio play strategy is a strategy for playing multi-channel data after performing audio conversion and/or encryption of the multi-channel data.

As a feasible implementation, the audio data conversion is performed for the multi-channel data at first to obtain target converted audio data, and then the target converted audio data is encrypted to improve the security of data transmission, and specifically, the target converted audio data is directly superimposed and encrypted on the basis of a noise level of reference audio data in a target scene. In another embodiment, in order to effectively improve the security of data interaction, a first reverse noise level of the reference audio data is generated on the basis of the noise level and a time domain horizontal line of the reference audio data, and then the first reverse noise level and the target converted audio data are mixed and encrypted. Also, in order to identify multi-channel data and conventional audio data (for example, music), an identification tag is added to the target converted audio data to obtain the target audio data.

As another feasible implementation, in order to improve the efficiency of multi-channel data transmission, the audio conversion and establishing are performed simultaneously for the multi-channel data to obtain the established audio data by means of a preset data conversion and establishing. Specifically, according to a preset multi-channel audio conversion and establishing rule, the multi-channel data are divided and established simultaneously to obtain the established audio data formed by multi-channel establishing. For example, data are collected through a MIC audio sensor, a Voice ACC audio sensor, an IMU inertial sensor, an IR infrared sensor, a visual sensor and a gravity sensor, and then data collected by different sensors are divided into dual-channel audio data. As an example, the data collected by a MIC audio sensor, a Voice ACC audio sensor and an IMU inertial sensor are divided into right channel data, and the data collected by an IR infrared sensor, a visual sensor and a gravity sensor are divided into left channel data, so as to establish and form dual-channel audio data, thereby realizing the transmission of multi-channel and multi-type data by the form of audio and improving the efficiency of data transmission. Furthermore, the established audio data is encrypted, and the encryption process of the established audio data is the same as the above encryption process, so as to obtain the target audio data, which will not be repeated here.

Step S30: playing the target audio data to be received by a second device, and analyzing the target audio data to obtain the multi-channel data.

In the embodiment, specifically, the target audio data is played by the external speaker in the first device, so that the target audio data is received by a receiving terminal of the second device, that is, a feedforward mic of the second device. Then, it is determined whether the target audio data has a preset identification tag, if not, the target audio data is directly played by a front speaker of the second device, and if so, it is confirmed that the target audio data is data formed by the multi-channel data establishing, and then a corresponding second reverse noise level is generated according to the noise level of the reference audio data pre-stored by the second device, the second reverse noise level is used as a private key for decrypting the target audio data, to decrypt the target audio data and obtain the decrypted target audio data. Accordingly, when a receiving terminal user is in the same environment scene as a playing terminal user, and the calculated second reverse noise level is the same as the first reverse noise level at the time of encryption when being below a certain tolerance deviation, and the target audio data can be correctly decrypted, thereby improving the security of data transmission. Further, according to the multi-channel audio conversion and establishing rule in the above step S20, the decrypted target audio data is analyzed to obtain different types of data, that is, the multi-channel data, and different types of multi-channel data is transmitted by audio. In addition, when the multi-channel data is data collected by sensors such as a MIC audio sensor, a Voice ACC audio sensor, an IMU inertial sensor, an IR infrared sensor, a visual sensor and a gravity sensor, etc., positioning information corresponding to the first device can be determined on the basis of the data collected by positioning type sensors such as a IR infrared sensor, a visual sensor, etc., thereby spatial assisted positioning can be realized for users by sound, mapping the spatial relationship of the real world into the virtual scene, and integrating the virtual and the real to enhance the user experience.

The present disclosure provides an audio-based multi-channel data transmission method. In the embodiment of the present disclosure, multi-channel data in a target scene is obtained at first, and then the multi-channel data is processed on the basis of a preset audio play strategy to obtain target audio data, further, the target audio data is played to be received by a second device and the target audio data is analyzed to obtain the multi-channel data, thereby processing data into the form of audio data for data transmission, thereby eliminating the need to use a network, therefore, even when the network signal is poor, data transmission can be achieved, and a plurality of different types of data can be transmitted simultaneously in the form of audio, thereby greatly improving data efficiency.

Furthermore, referring to FIG. 3, based on the first embodiment of the present disclosure, in another embodiment of the present disclosure, the step of processing the multi-channel data on the basis of a preset audio play strategy to obtain target audio data includes:

Step S21: performing audio data conversion and establishing for the multi-channel data according to a preset multi-way tree rule to obtain established audio data.

In the embodiment, it should be noted that the preset multi-way tree rule is converting and assembling the multi-channel data into audio data with a preset number of channels, wherein the multi-channel data is used as a child node, and a corresponding parent node is configured for the multi-channel data. Preferably, the embodiment adopts a 48 kHz/16 bit dual-channel audio design, and therefore can support the simultaneous conversion and establishing of 6 types of 16 kHz/16 bit sensor data in an audio manner. Reference may be made to FIG. 4, which is a principle diagram of establishing different types of data into dual-channel audio data. Specifically, after acquiring the multi-channel data, different types of data are divided simultaneously to establish and form left and right dual-channel audio data, and the left and right dual-channel audio data are used as the established audio data.

Step S22: acquiring a noise level of pre-saved reference audio data.

Step S23: encrypting the established audio data on the basis of the noise level to obtain the target audio data.

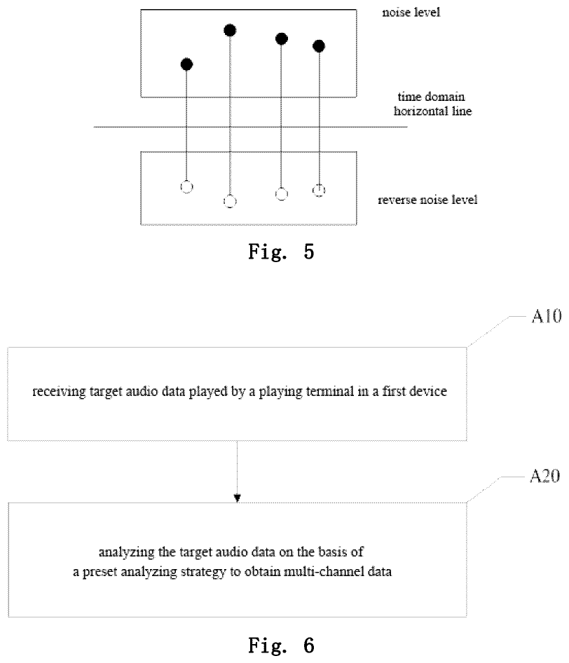

In the embodiment, it should be noted that, since the environmental noise level below a preset deviation can be regarded as the same in the same environmental scene, in order to achieve data reception only when two users are in the same environmental scene to improve the security of data transmission, the present embodiment encrypts the established audio data on the basis of the noise level of the reference audio data. Specifically, a noise level corresponding to the reference audio data is acquired, and a time domain horizontal line of the reference audio data is determined. Here, the time domain horizontal line is determined according to a change in volume of the reference audio data in a process of propagation, and then a first reverse noise level is generated on the basis of the time domain horizontal line and the noise level. Reference may be made to FIG. 5, which is a principle diagram of generating the first reverse noise level in the embodiment of the present disclosure. Accordingly, the first reverse noise level and the established audio data are mixed and encrypted. In addition, in order to identify multi-channel data and conventional audio data (for example, music), an identification tag is added to the target converted audio data to obtain the target audio data.

According to the above-mentioned solutions of the embodiment of the present disclosure, based on the preset multi-way tree rule, audio data conversion and establishing are performed for the multi-channel data to obtain established audio data, and then a noise level of the pre-saved reference audio data is acquired. Further, the established audio data is encrypted on the basis of the noise level to obtain the target audio data, thereby performing the audio data conversion on the multi-channel data, realizing data transmission by adopting audio form, and establishing the multi-channel data, thereby improving the transmission efficiency of the multi-channel data. In addition, the established audio data is encrypted to effectively improve the security of data transmission.

The present disclosure provides an audio-based multi-channel data transmission method, which is applied to a second device. In a third embodiment of the audio-based multi-channel data transmission method in the present disclosure, as shown in FIG. 6, the audio-based multi-channel data transmission method includes:
Step A10: receiving target audio data played by a playing terminal in a first device; and
Step A20: analyzing the target audio data on the basis of a preset analyzing strategy to obtain multi-channel data.

In the embodiment, a hardware module structure of the second device is consistent with the hardware module structure of the first device, and the preset analyzing strategy includes strategies such as decrypting the target audio data and/or analyzing the data type, and it should be noted that the reference audio data is played in advance through an external speaker (playing terminal) of the second device, wherein the reference audio data may be the same as the reference audio data played by the first device, thereby the reference audio data is received by a feedforward mic (receiving terminal) in the second device, so that spontaneous transmission and reception of audio is realized through the playing terminal and the receiving terminal in the second device, so as to calculate and store the noise level and the distance attenuation sensitivity of the reference audio data in the target scene. Specifically, after receiving the target audio data played by the playing terminal in the first device, whether the target audio data belongs to audio data formed by multi-audio data establishing is determined according to a preset identification tag at first, if not, the target audio data is played directly through a front speaker of the second device; if so, it will enter a decryption and data type analyzing stage, that is, acquiring the noise level of the pre-saved reference audio data, and then generating a reverse noise level of the reference audio data on the basis of the time domain horizontal line of the reference audio data, using the reverse noise level as a decryption private key of the target audio data, so as to perform decryption processing on the target audio data and obtain the decrypted target audio data. In addition, in order to avoid the interference of the reverse noise level on the normal audio data, in the present embodiment, the reverse noise level is played through Active Noise Cancellation (ANC) mode. Furthermore, since the target audio data is formed by converting and establishing the multi-channel data according to the preset multi-way tree rule and then encrypting, the decrypted target audio data is the established audio data corresponding to the left and right dual-channel audio data. In order to obtain the multi-channel data, it is also necessary to analyze the established audio data according to the multi-way tree rule to obtain different types of data, that is, to obtain the multi-channel data, so as to realize the data interaction between the first device and the second device. Since the multi-channel data are data collected by sensors such as a MIC audio sensor, a Voice ACC audio sensor, an IMU inertial sensor, an IR infrared sensor, a visual sensor, a gravity sensor, etc., information such as audio information, inertial information and positioning information for interaction of the first device can be extracted on the basis of the multi-channel data, accordingly, the reverse noise level serves as a decryption private key of the target audio data, so that when the receiving terminal user is in the same environment scene as the playing terminal user, the received target audio data can be correctly decrypted, thereby improving the security of data transmission, and determining the positioning information on the basis of the multi-channel data, realizing the mapping of the spatial relationship of the real world to the virtual scene, and improving the user experience.

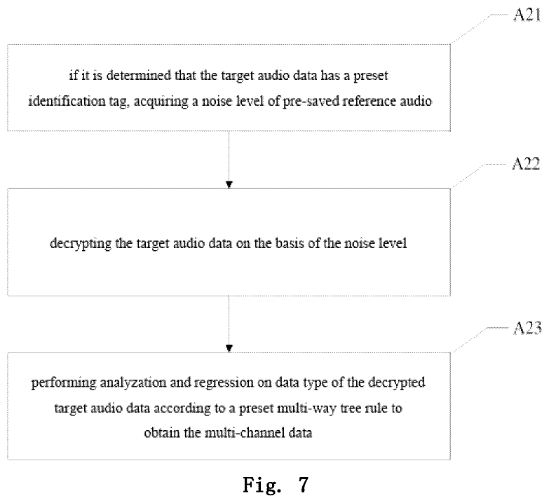

Furthermore, referring to FIG. 7, based on the third embodiment of the present disclosure, in another embodiment of the present disclosure, the step of analyzing the target audio data on the basis of a preset analyzing strategy to obtain multi-channel data includes:
Step A21: if it is determined that the target audio data has a preset identification tag, acquiring a noise level of the pre-saved reference audio;
Step A22: decrypting the target audio data on the basis of the noise level; and
Step A23: performing analyzation and regression on data type of the decrypted target audio data according to a preset multi-way tree rule to obtain the multi-channel data.

In the embodiment, it should be noted that, since the preset identification tag is added to the target audio data during the encryption process of the first device, it is possible to determine whether the received target audio data is audio data formed by multi-channel data on the basis of the preset identification tag. Specifically, it is detected whether the target audio data has a preset identification tag, if not, the target audio data is directly played by a front speaker of the second device, and if so, it is confirmed that it is necessary to perform decryption processing on the target audio data. Specifically, acquiring a noise level of the pre-saved reference audio data, and generating a second reverse noise level on the basis of the noise level and the time domain horizontal line of the reference audio data. Since when the receiving terminal user is in the same environment scene as the playing terminal user, the calculated second reverse noise level is the same as the first reverse noise level at the time of encryption when being below a certain tolerance deviation, so that the target audio data can be correctly decrypted, that is, target audio data can be decrypted only when the receiving terminal user is in the same environment scene as the playing terminal user, thereby improving the security of data transmission, and further, using the second reverse noise level as a decryption key of the target audio data to decrypt the target audio data, so as to obtain the decrypted target audio data. Furthermore, the data type regression is performed on the decrypted target audio data according to the preset multi-way tree rule, so as to obtain the multi-channel data.

According to the above-mentioned solution of the embodiment of the present disclosure, if it is determined that the target audio data has a preset identification tag, acquiring a noise level of the pre-saved reference audio data, and then decrypting the target audio data on the basis of the noise level, furthermore, performing analyzation and regression on data type of the decrypted target audio data according to the preset multi-way tree rule to obtain the multi-channel data, so that the received target audio data can be correctly decrypted only when the receiving terminal user and the playing terminal user are in the same environment scene, thereby improving the security of data transmission.

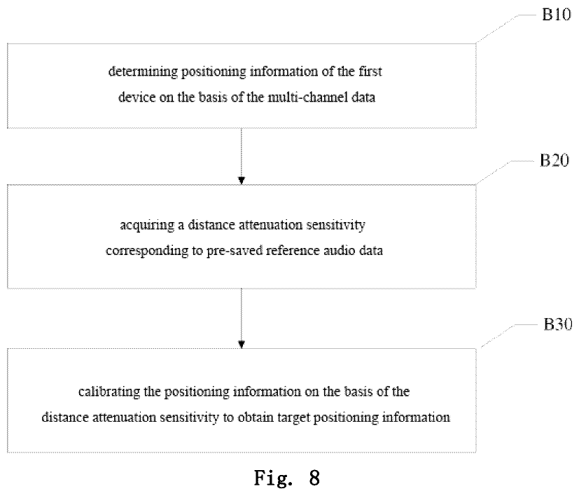

Furthermore, referring to FIG. 8, according to the third embodiment of the present disclosure, in another embodiment of the present disclosure, after the step of analyzing the target audio data on the basis of a preset analyzing strategy to obtain multi-channel data, the method further includes:
Step B10: determining positioning information of the first device on the basis of the multi-channel data;
Step B20: acquiring a distance attenuation sensitivity corresponding to the pre-saved reference audio data; and
Step B30: calibrating the positioning information on the basis of the distance attenuation sensitivity to obtain target positioning information.

It should be noted that, in the prior art, the perception of users by each other in a virtual scene is completely separated from the spatial position relationship in a real scene, whereas in the present embodiment, specifically, positioning data that can be used to characterize the positioning position is extracted from the multi-channel data, for example, extracting data collected by an IR infrared sensor and a visual sensor, and then, determining the positioning information of the first device on the basis of the positioning data, that is, the position information of the user using the first device can be determined. Since the distance information may be attenuated during a process of the data transmission, therefore, in order to improve the positioning accuracy, the present embodiment can determine the attenuation of the distance information at the transmission distance by referring to the distance attenuation sensitivity corresponding to the audio data, and then calibrate the positioning information on the basis of the distance attenuation sensitivity to obtain the target positioning information. Here, the calibration method is: p=∂(α,β), wherein p represents target positioning information, ∂(α,β) represents a function of calibration positioning, a represents positioning information extracted from the target audio data of the first device, and β represents distance information obtained on the basis of the distance attenuation sensitivity, thereby realizing the mapping of the spatial relationship of the real world into the virtual scene.

According to the above-mentioned solution of the embodiment of the present disclosure, by means of determining positioning information of the first device on the basis of the multi-channel data, and then acquiring a distance attenuation sensitivity corresponding to the pre-saved reference audio data, furthermore, calibrating the positioning information on the basis the distance attenuation sensitivity to obtain the target positioning information, it is possible to determine the positioning information on the basis of the multi-channel data transmitted by the first device, and calibrating the positioning information on the basis of the distance attenuation sensitivity, thereby reducing the effect of data attenuation during a process of the transmission, improving the accuracy of positioning, and mapping the spatial relationship of the real world into the virtual scene, and thereby effectively improving the user experience.

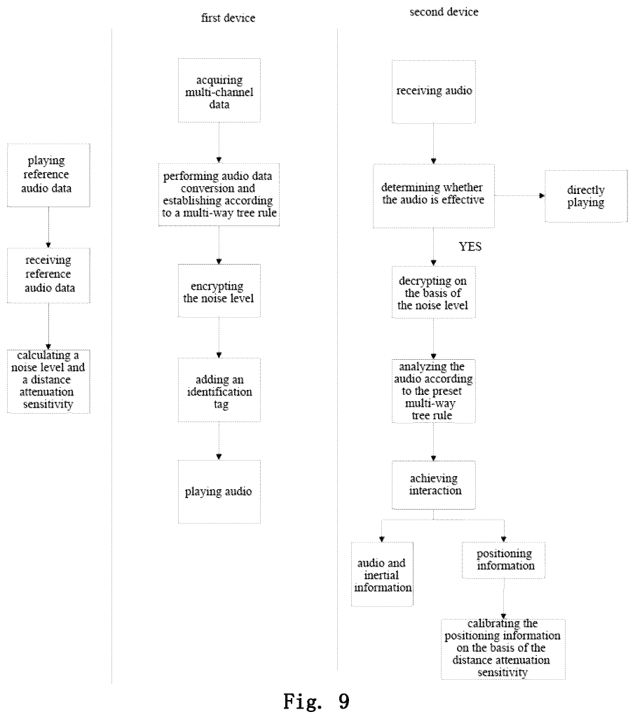

Furthermore, referring to FIG. 9, which is a schematic diagram of the overall process of the audio-based multi-channel data transmission method of the present disclosure. Specifically, preset reference audio data is broadcast through an external speaker (playing terminal) of the device at first, and then reference audio data is received through a feedforward mic (receiving terminal) of the device, so as to calculate a noise level in the current target scene and distance attenuation sensitivity corresponding to the audio data. Furthermore, data are collected by different types of sensors in the first device to obtain multi-channel data, and then the multi-channel data is converted into audio data according to a multi-way tree rule and the multi-channel data is established to form audio data of preset channels. For example, data collected by a MIC audio sensor, a Voice ACC audio sensor, and an IMU inertial sensor are divided into right channel data, and data collected by an IR infrared sensor, a visual sensor, and a gravity sensor are divided into left channel data, so as to obtain dual-channel established audio data, and then, a time domain horizontal line of the reference audio data is determined, and a first reverse noise level is generated on the basis of the time domain horizontal line and the pre-calculated noise level. Furthermore, the first reverse noise level and the established audio data are superimposed and encrypted, and an identification tag is added to the established audio data to obtain target audio data, and then the target audio data is broadcasted. Further, the target audio data is received by a feedforward mic (receiving terminal) of the second device, and it is determined whether the target audio data has the added identification tag, if not, it is confirmed that the target audio data is conventional audio data (for example, music), and if so, it is confirmed that the target audio data is audio data formed by multi-channel data and the target audio data needs to be decrypted. Specifically, a corresponding second reverse noise level is generated on the basis of the noise level of the reference audio data. When the receiving terminal user is in the same environment scene as the playing terminal user, the second reverse noise level is the same as the first reverse noise level when being below a certain tolerance deviation, so that the second reverse noise level serves as a private key for decrypting the target audio data to improve the security of data transmission. Furthermore, since the first device performs conversion and establishing of the multi-channel data through the multi-way tree rule, it is also necessary to analyze the decrypted target audio data according to the multi-way tree rule to obtain multi-channel data for interaction of the first device, thereby eliminating the need for network transmission and realizing data transmission of different channels or different types by means of audio transmission, and accordingly, different types of interaction information can be determined on the basis of the multi-channel data. For example, audio information can be obtained by data collected by extracting the MIC audio sensor and the Voice ACC audio sensor, and inertial information can be obtained by extracting data collected by the IMU inertial sensor, and the positioning information of the first device can be determined by extracting data collected by the IR infrared sensor and the visual sensor. Furthermore, the positioning information is calibrated on the basis of the distance attenuation sensitivity to obtain calibrated positioning information, thereby improving the accuracy of positioning, and by means of mapping the spatial relationship of the real world into the virtual scene, the user experience is improved.

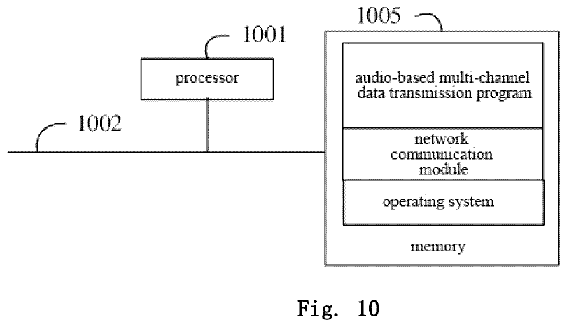

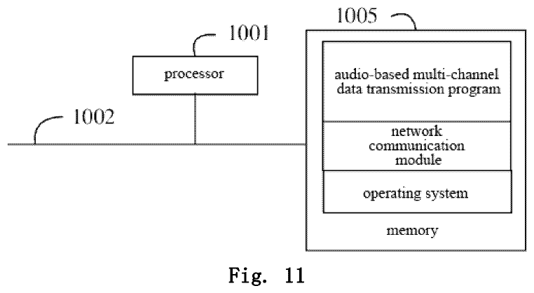

Referring to FIG. 10, FIG. 10 is a structural schematic diagram of an audio-based multi-channel data transmission device in a hardware operating environment according to an embodiment of the present disclosure.

As illustrated in FIG. 10, the audio-based multi-channel data transmission device may include: a processor 1001 such as a CPU; a memory 1005; and a communication bus 1002. The communication bus 1002 is used to realize connection and communication between the processor 1001 and the memory 1005. The memory 1005 may be a high-speed RAM memory or a stable memory (non-volatile memory), such as a disk memory. The memory 1005 may optionally be a storage device independent of the aforementioned processor 1001.

Optionally, the audio-based multi-channel data transmission device may further include a rectangular user interface, a network interface, a camera, a Radio Frequency (RF) circuit, a sensor, an audio circuit, a WIFI module, and the like. The rectangular user interface may include a display screen (Display), an input submodule such as a keyboard (Keyboard), and the rectangular user interface may optionally further include a standard wired interface and a wireless interface. The network interface may optionally include a standard wired interface or a wireless interface (such as a WIFI interface).

Those skilled in the art will appreciate that the structure of the audio-based multi-channel data transmission device structure shown in FIG. 10 does not constitute a limitation on the audio-based multi-channel data transmission device, and may include more or fewer components than that shown in the figures, or a combination of certain components, or a different arrangement of components.

As illustrated in FIG. 10, the memory 1005 as a computer storage medium may include an operating network communication module and an audio-based multi-channel data transmission program. The operating device is a program for managing and controlling hardware and software resources of audio-based multi-channel data transmission, and supports the operation of the audio-based multi-channel data transmission program and other software and/or programs. The network communication module is used to realize communication between the components inside the memory 1005 and communicate with other hardware and software in the audio-based multi-channel data transmission device.

In the audio-based multi-channel data transmission device shown in FIG. 10, the processor 1001 is used to execute the audio-based multi-channel data transmission program stored in the memory 1005, and implement the steps of any one of the audio-based multi-channel data transmission methods described above.

The specific implementations of the audio-based multi-channel data transmission device of the present disclosure are substantially the same as the above-mentioned embodiments of the audio-based multi-channel data transmission method, and will not be repeated here.

Furthermore, referring to FIG. 11, FIG. 11 is a schematic diagram of functional modules of audio-based multi-channel data transmission apparatus of the present disclosure. The present disclosure also provides audio-based multi-channel data transmission apparatus, which is applied to a first device. The audio-based multi-channel data transmission apparatus includes:
an acquisition module configured to acquire multi-channel data in a target scene;
a processing module configured to process the multi-channel data on the basis of a preset audio play strategy to obtain target audio data; and
a playing module configured to play the target audio data to be received by a second device and to analyze the target audio data to obtain the multi-channel data.

Optionally, the processing module is further configured for:
performing audio data conversion and establishing for the multi-channel data according to a preset multi-way tree rule to obtain established audio data;
acquiring a noise level of a pre-saved reference audio data; and
encrypting the established audio data on the basis of the noise level to obtain the target audio data.

Optionally, the processing module is further configured for:
determining a time domain horizontal line of the reference audio data;
generating a first inverse noise level of the reference audio data on the basis of the time domain horizontal line and the noise level; and
superimposing and encrypting the first reverse noise level and the established audio data and adding a preset identification tag to the established audio data to obtain the target audio data.

Optionally, the audio-based multi-channel data transmission apparatus is further configured for:
playing preset reference audio data in a target scene so that a receiving terminal in the first device receives the reference audio data; and
calculating and saving a noise level and a distance attenuation sensitivity of the reference audio data on the basis of the played reference audio data and the received reference audio data.

The present disclosure also provides audio-based multi-channel data transmission apparatus, which is applied to a second device. The audio-based multi-channel data transmission apparatus includes:
a receiving module configured to receive target audio data played by a playing terminal in a first device; and
a analyzing module configured to analyze the target audio data on the basis of a preset analyzing strategy to obtain multi-channel data.

Optionally, the audio-based multi-channel data transmission apparatus is further configured for:
determining positioning information of the first device on the basis of the multi-channel data;
acquiring a distance attenuation sensitivity corresponding to pre-saved reference audio data; and
calibrating the positioning information on the basis of the distance attenuation sensitivity to obtain target positioning information.

Optionally, the analyzing module is further configured for:
acquiring a noise level of the pre-saved reference audio if it is determined that the target audio data has a preset identification tag;
decrypting the target audio data on the basis of the noise level; and
performing analyzation and regression on data type of the decrypted target audio data according to a preset multi-way tree rule to obtain the multi-channel data.

Optionally, the analyzing module is further configured for:
generating a second inverse noise level on the basis of the noise level; and
decrypting the target audio data on the basis of the second inverse noise level.

The specific implementations of the audio-based multi-channel data transmission apparatus of the present disclosure are substantially the same as the above-mentioned embodiments of the audio-based multi-channel data transmission method, and will not be repeated herein.

The present disclosure also provides a storage medium, which is a computer-readable storage medium, wherein the computer-readable storage medium stores one or more programs, and the one or more programs may also be executed by one or more processors to implement the steps of any one of the audio-based multi-channel data transmission methods described above.

The specific implementations of the computer-readable storage medium of the present disclosure are substantially the same as the above-mentioned embodiments of the audio-based multi-channel data transmission method, and will not be repeated herein.

The above are only preferred embodiments of the present disclosure, and are not intended to limit the patent scope of the present disclosure. Any equivalent structure or equivalent process transformation made by using the contents of specification and drawings of the present disclosure, or directly/indirectly applications in other related technical fields, are included in the patent scope of the present disclosure.

It should be noted that terms such as “include”, “comprise” or any other variation thereof are intended to encompass a non-exclusive inclusion such that a process, method, article or system that includes a series of elements includes not only those elements, but also other elements not explicitly listed, or elements inherent to such a process, method, article or system. Without further limitation, the element defined by the phrase “including a . . . ” does not preclude the presence of additional identical elements in the process, method, article or system including the element.

The serial numbers of the above-mentioned embodiments of the present disclosure are for description only and do not represent the advantages or disadvantages of the embodiments.

According to the description of the above implementations, those skilled in the art can clearly understand that the above embodiment methods can be implemented by means of software and a necessary general hardware platform, and of course by hardware, but in many cases, the former is a better implementation. Based on this understanding, the technical solution of the present disclosure can essentially be embodied in the form of a software product or a part that contributes to the prior art can be embodied in the form of a software product. The computer software product is stored in a storage medium (such as ROM/RAM, disk, or CD) as described above, and includes a number of instructions for enabling a terminal device (which may be a mobile phone, a computer, a server, an air conditioner, or a network device, etc.) to execute the methods described in the various embodiments of the present disclosure.

The above are only preferred embodiments of the present disclosure, and are not intended to limit the patent scope of the present disclosure. Any equivalent structure or equivalent process transformation made by using the contents of specification and drawings of the present disclosure, or directly/indirectly applications in other related technical fields, are included in the patent scope of the present disclosure.

The various embodiments in this specification are described in a parallel or progressive manner, and each embodiment focuses on the differences from other embodiments, and the same or similar parts between the various embodiments may be referred to each other. As for the apparatus disclosed in the embodiment, since it corresponds to the method disclosed in the embodiment, the description is relatively simple. For relevant parts, please refer to the description of the method.

Those of ordinary skill in the art will understand that the units and algorithm steps of each example described in conjunction with the embodiments disclosed herein can be implemented by electronic hardware, computer software, or a combination thereof. In order to clearly explain the interchangeability of hardware and software, the composition and steps of each example have been generally described in the above description in terms of function. Whether these functions are performed in hardware or software depends on the specific application and design constraints of the technical solution. Those skilled in the art may implement the described functions by using different methods for each specific application, but such implementations should not be considered beyond the scope of the present disclosure.

1. An audio-based multi-channel data transmission method, wherein the audio-based multi-channel data transmission method is applied to a first device, the first device at least comprises a playing terminal, the audio-based multi-channel data transmission method comprises steps:
acquiring multi-channel data in a target scene;
processing the multi-channel data on the basis of a preset audio play strategy to obtain target audio data; and
playing the target audio data to be received by a second device, and analyzing the target audio data to obtain the multi-channel data.

2. The audio-based multi-channel data transmission method of claim 1, wherein the step of processing the multi-channel data on the basis of a preset audio play strategy to obtain target audio data comprises:
performing audio data conversion and establishing of the multi-channel data according to a preset multi-way tree rule to obtain established audio data;
acquiring a noise level of pre-saved reference audio data; and
mixing and encrypting the established audio data on the basis of the noise level to obtain the target audio data.

3. The audio-based multi-channel data transmission method of claim 2, wherein the step of mixing and encrypting the established audio data on the basis of the noise level to obtain the target audio data comprises:
determining a time domain horizontal line of the reference audio data;
generating a first inverse noise level of the reference audio data on the basis of the time domain horizontal line and the noise level; and
superimposing and encrypting the first reverse noise level and the established audio data and adding a preset identification tag to the established audio data to obtain the target audio data.

4. The audio-based multi-channel data transmission method of claim 1, wherein the first device at least further comprises a receiving terminal, and before the step of acquiring multi-channel data in a target scene, the audio-based multi-channel data transmission method further comprises:
playing preset reference audio data in the target scene, so that the receiving terminal in the first device receives the reference audio data; and
calculating and saving a noise level and a distance attenuation sensitivity of the reference audio data on the basis of the played reference audio data and the received reference audio data.

5. An audio-based multi-channel data transmission method, wherein the audio-based multi-channel data transmission method is applied to a second device, the second device at least comprises a receiving terminal, the audio-based multi-channel data transmission method comprises steps:
receiving target audio data played by a playing terminal in a first device; and
analyzing the target audio data on the basis of a preset analyzing strategy to obtain multi-channel data.

6. The audio-based multi-channel data transmission method of claim 5, wherein after the step of analyzing the target audio data on the basis of a preset analyzing strategy to obtain multi-channel data, the audio-based multi-channel data transmission method further comprises:
determining positioning information of the first device on the basis of the multi-channel data;
acquiring a distance attenuation sensitivity corresponding to pre-saved reference audio data; and
calibrating the positioning information on the basis of the distance attenuation sensitivity to obtain target positioning information.

7. The audio-based multi-channel data transmission method of claim 5, wherein the step of analyzing the target audio data on the basis of a preset analyzing strategy to obtain multi-channel data comprises:
if it is determined that the target audio data has a preset identification tag, acquiring a noise level of pre-saved reference audio;
decrypting the target audio data on the basis of the noise level; and
performing analyzation and regression on data type of the decrypted target audio data according to a preset multi-way tree rule to obtain the multi-channel data.

8. The audio-based multi-channel data transmission method of claim 7, wherein the step of decrypting the target audio data on the basis of the noise level comprises:
generating a second inverse noise level on the basis of the noise level; and
decrypting the target audio data on the basis of the second inverse noise level.

9. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 1.

10. A storage medium, which is a computer-readable storage medium, wherein an audio-based multi-channel data transmission program is stored in the computer-readable storage medium, and
wherein the audio-based multi-channel data transmission program is executed by a processor to implement steps of the audio-based multi-channel data transmission method of claim 1.

11. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 2.

12. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 3.

13. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 4.

14. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 5.

15. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 6.

16. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 7.

17. An audio-based multi-channel data transmission device, comprising a memory, a processor, and an audio-based multi-channel data transmission program stored in the memory,
wherein the audio-based multi-channel data transmission program is executed by the processor to implement steps of the audio-based multi-channel data transmission method of claim 8.

18. A storage medium, which is a computer-readable storage medium, wherein an audio-based multi-channel data transmission program is stored in the computer-readable storage medium, and
wherein the audio-based multi-channel data transmission program is executed by a processor to implement steps of the audio-based multi-channel data transmission method of claim 3.

19. A storage medium, which is a computer-readable storage medium, wherein an audio-based multi-channel data transmission program is stored in the computer-readable storage medium, and
wherein the audio-based multi-channel data transmission program is executed by a processor to implement steps of the audio-based multi-channel data transmission method of claim 4.

20. A storage medium, which is a computer-readable storage medium, wherein an audio-based multi-channel data transmission program is stored in the computer-readable storage medium, and
wherein the audio-based multi-channel data transmission program is executed by a processor to implement steps of the audio-based multi-channel data transmission method of claim 5.
